(19) United States
(12) Patent Application Publication
(10) Pub. No.: US 2012/0051865 A1
(43) Pub. Date: Mar. 1, 2012

(54) CLAMPING APPARATUS FOR DRILLING OBLIQUE HOLES

(76) Inventor: Yu-Chun LIU, Shangkang Hsiang (TW)

(21) Appl. No.: 12/872,442

(22) Filed: Aug. 31, 2010

(51) Int. Cl. B23B 45/14; B23B 47/34; B23B 49/02

(52) U.S. Cl. 408/108; 408/72 B; 269/87.3

(57) ABSTRACT

A clamping apparatus for drilling oblique holes has a clamping device and a guiding device. The clamping device has a positioning set and a clamping set. The positioning set has a positioning arm and an operating handle. The operating handle is pivotally connected to the positioning arm and has a release lever and a pushing lever. The clamping set is pivotally connected to the positioning set and has a clamping arm and an adjusting shaft. The clamping arm is pivotally connected to the positioning arm and has a holding grip. The adjusting shaft is rotatably connected to the holding grip. The guiding device is detachably and adjustably connected to the clamping device and has a guiding mount. The guiding mount is detachably and adjustably connected to the clamping arm and has a guiding hole.

### BACKGROUND OF THE INVENTION

1. Field of the Invention

The present invention relates to a clamping apparatus, and more particularly relates to a clamping apparatus that can be carried and can drill oblique holes in a wood work-piece conveniently.

2. Description of Related Art

A conventional clamping apparatus can hold a wood work-piece in position to drill oblique holes in the wood work-piece with a drill or a bit, such that two wood work-pieces with oblique holes can be vertically connected with each other with fasteners. The conventional clamping apparatus has a base, a guiding frame and a clamping seat. The base has a top face and two ends. The guiding frame is securely mounted on the top face of the base near one of the ends of the base and has a top, a sidewall and two guiding holes. The guiding holes are obliquely formed through the guiding frame from the top to the sidewall of the guiding frame at an interval. The clamping seat is movably mounted on the top face of the base near the other end of the base and faces the sidewall of the guiding frame. A wood work-piece can be securely held on the top face of the base between the guiding frame and the clamping seat by moving the clamping seat toward the guiding frame. When the wood work-piece is securely held on the base, a drill or a bit can be inserted into one of the guiding holes of the guiding frame to drill an oblique hole in the wood work-piece.

However, the conventional clamping apparatus has a large volume and a heavy weight and cannot be carried easily. In addition, the guiding frame is securely mounted on the top face of the base and cannot be adjusted to fit the wood work-pieces with different shapes and this causes inconvenient in use.

Therefore, the present invention provides a clamping apparatus for drilling oblique holes to mitigate or obviate the aforementioned problems.

### SUMMARY OF THE INVENTION

The main objective of the present invention is to provide a clamping apparatus for drilling oblique holes that can be carried and can drill oblique holes in a wood work-piece conveniently.

The clamping apparatus for drilling oblique holes in accordance with the present invention has a clamping device and a guiding device. The clamping device has a positioning set and a clamping set. The positioning set has a positioning arm and an operating handle. The operating handle is pivotally connected to the positioning arm and has a release lever and a pushing lever. The clamping set is pivotally connected to the positioning set and has a clamping arm and an adjusting shaft. The clamping arm is pivotally connected to the positioning arm and has a holding grip. The adjusting shaft is rotatably connected to the holding grip. The guiding device is detachably and adjustably connected to the clamping device and has a guiding mount. The guiding mount is detachably and adjustably connected to the clamping arm and has a guiding hole.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a clamping apparatus for drilling oblique holes in accordance with the present invention;

FIG. 2 is an exploded perspective view of the clamping apparatus in FIG. 1;

FIG. 3 is an operational side view of the clamping apparatus in FIG. 1;

FIG. 4 is an operational side view of the clamping apparatus in FIG. 1 to hold a wood work-piece;

FIG. 5 is an enlarged operational side view in partial section of the clamping apparatus in FIG. 4;

FIG. 6 is an operational perspective operational view of the clamping apparatus in FIG. 1 showing the guiding device being adjusted relative to the clamping device.

### DETAILED DESCRIPTION OF THE PREFERRED EMBODIMENT

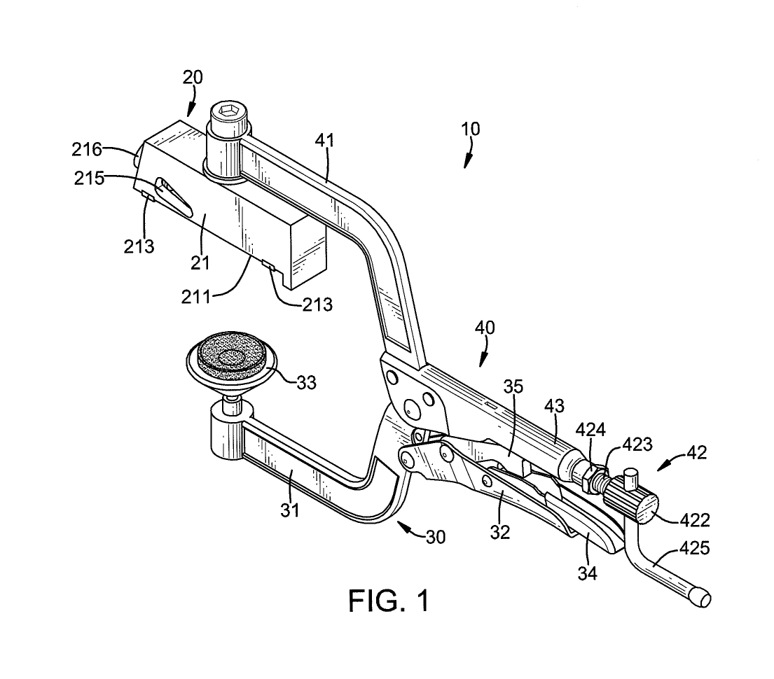

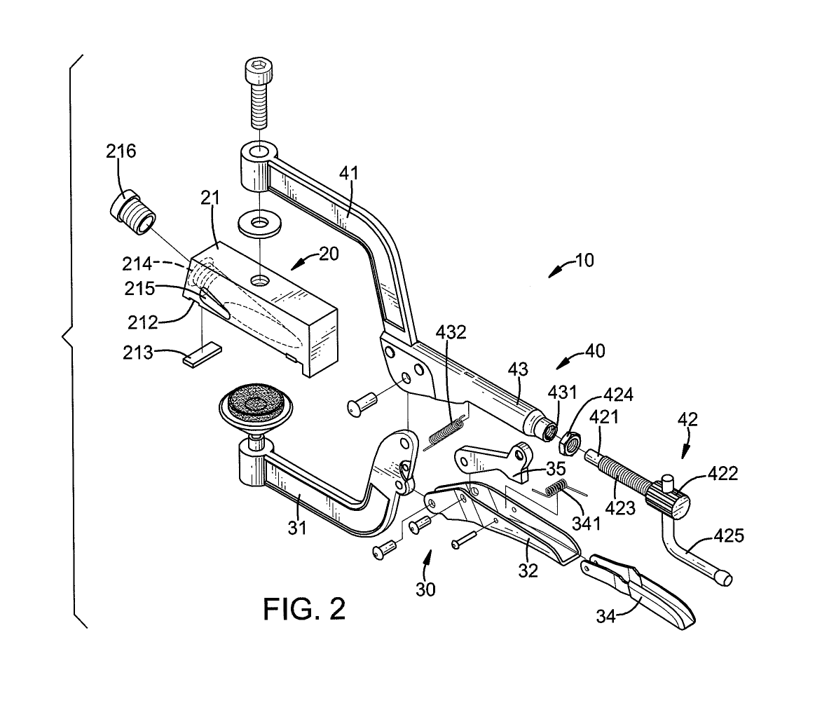

With reference to FIGS. 1 to 3, a clamping apparatus in accordance with the present invention for drilling oblique holes comprises a clamping device 10 and a guiding device 20.

The clamping device 10 has a positioning set 30 and a clamping set 40. The positioning set 30 has a positioning arm 31 and an operating handle 32. The positioning arm 31 may be L-shaped and has a front end, a rear end and a locating pad 33. The locating pad 33 is rotatably connected to the front end of the positioning arm 31 and has a universal bearing 331 to allow the locating pad 33 rotating relative to the front end of the positioning arm 31.

The operating handle 32 is pivotally connected to the positioning arm 31 and has a front end, a rear end, a middle, a release lever 34 and a pushing lever 35. The front end of the operating handle 32 is pivotally connected to the positioning arm 31 near the rear end of the positioning arm 31. The release lever 34 is pivotally connected to the middle of the operating handle 32 and has a pivotal end, a releasing end and a torsional spring 341. The pivotal end of the release lever 34 is pivotally connected to the middle of the operating handle by a pivot. The releasing end of the release lever 34 extends out of the rear end of the operating handle 32. The torsional spring 341 is mounted around the pivot and has two ends respectively abutting the operating handle 32 and the release lever 34.

The pushing lever 35 is pivotally connected to the operating handle 32, abuts the release lever 34 and has a front end and a rear end. The front end of the pushing lever 35 is pivotally connected to the operating handle 32 between middle and the front end of the operating handle 32.

The clamping set 40 is pivotally connected to the positioning set 30 and has a clamping arm 41 and an adjusting shaft 42. The clamping arm 41 is pivotally connected to the positioning arm 31 and has a front end, a rear end, a middle and a holding grip 43. The front end of the clamping arm 41 has a shape corresponding to that of the positioning arm 31 to hold a wood work-piece 50 between the arms 31, 41. The middle of the clamping arm 41 is pivotally connected to the rear end of the positioning arm 31. The holding grip 43 is formed on the rear end of the clamping arm 41 and has a side face, a slit, an adjusting hole 431 and a returning spring 432. The side face of the holding grip 43 faces the operating handle 32. The slit is formed through the side face of the holding grip 43. The adjusting hole 431 is threaded, is formed in the holding grip 43 at an end opposite to the front end of the clamping arm 41 and communicates with the slit of the holding grip 43. The returning spring 432 mounted between the clamping arm 41 and the positioning arm 31 and has two ends connected respectively to the holding grip 43 and the positioning arm 31 at a position near the rear end of the positioning arm 31. The rear end of the pushing lever 35 extends in the holding grip 43 via the slit of the holding grip 43 between the adjusting hole 431 and the returning spring 432.

The adjusting shaft 42 is rotatably connected to the holding grip 43 of the clamping arm 41 and has an external surface, an abutting end 421, an operating end 422, an outer thread 423, an adjusting nut 424 and a rotating shaft 425. The abutting end 421 of the adjusting shaft 42 is mounted in the adjusting hole 431 of the holding grip 43 and selectively abuts the rear end of the pushing lever 35. The operating end 422 of the adjusting shaft 42 extends out of the holding grip 43. The outer thread 423 is formed around the external surface of the adjusting shaft 42 between the abutting end 421 and the operating end 422 and is screwed with the adjusting hole 431 of the holding grip 43. The adjusting nut 424 is adjustably and rotatably mounted around the external surface of the adjusting shaft 42. The rotating shaft 425 may be L-shaped and is connected to the operating end 422 of the adjusting shaft 42 to allow a user rotating the adjusting shaft 42 relative to the holding grip 43.

The guiding device 20 is detachably and adjustably connected to the clamping device 10 and has a guiding mount 21. The guiding mount 21 is detachably and adjustably connected to the front end of the clamping arm 41 and has a top, a bottom, a front side, two opposite sidewalls, an abutting face 211, at least one mounting recess 212, a guiding hole 214, two chip-removal holes 215 and a protecting plug 216. The top of the guiding mount 21 is adjustably connected to the front end of the clamping arm 41 by a fastener. The abutting face 211 is formed on the bottom of the guiding mount 21 and faces the locating pad 31. The at least one mounting recess 212 is transversely formed in the abutting face 211 of the guiding mount 21 and each one of the at least one mounting recess 212 has an anti-skid strip 213 mounted in the mounting recess 212. The guiding hole 214 is obliquely formed through the guiding mount 21 from the front side to the bottom of the guiding mount 21. The chip-removal holes 215 are respectively formed through the opposite sidewalls of the guiding mount 21 and communicate with the guiding hole 214. The protecting plug 216 is mounted in the guiding hole 214 at the front side of the guiding mount 21 and has a through hole defined axially through the plug 216 to provide a guiding effect to a drill or a bit and to prevent a drill or a bit from scraping the guiding mount 21.

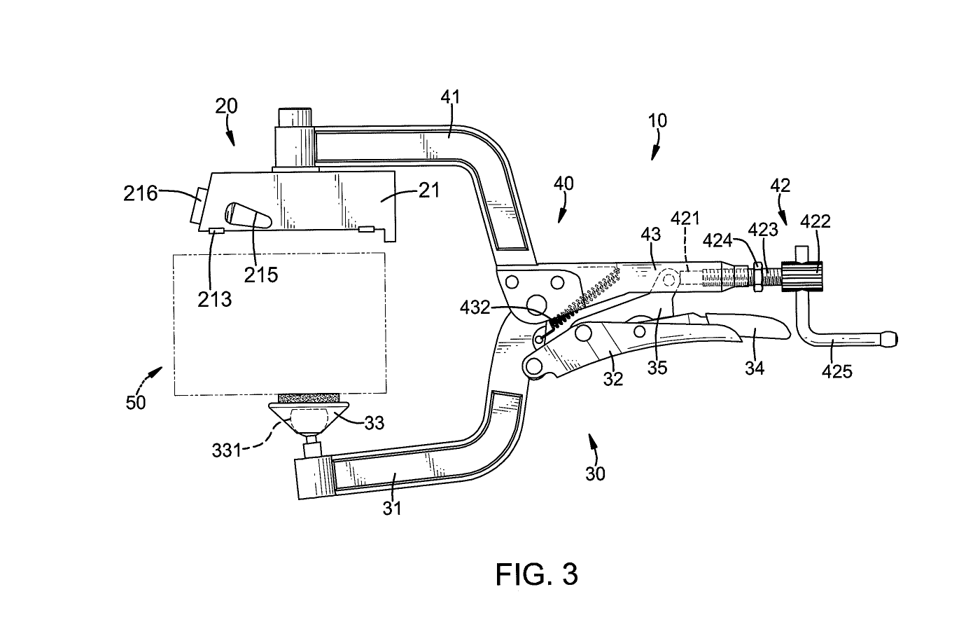

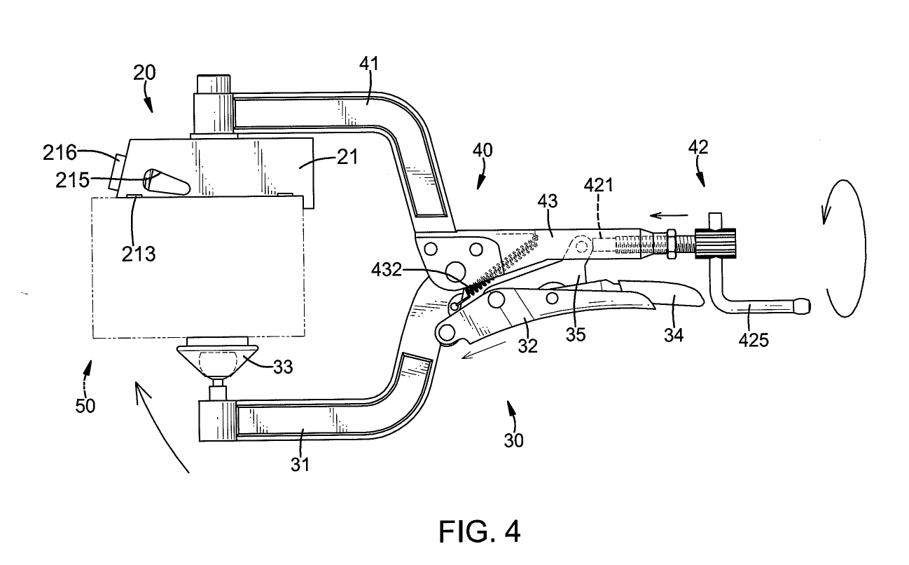

With reference to FIGS. 3 and 4, to drill an oblique hole in a wood work-piece 50, the wood work-piece 50 is placed between the clamping arm 41 and the positioning arm 31 and the operating handle 32 and the holding grip 43 are pressed. With the abutting end 421 of the adjusting shaft 42 abutting against the rear end of the pushing lever 35, the abutting face 211 of the guiding mount 21 and the locating pad 33 of the positioning arm 31 move toward each other with the transmission of the pushing lever 35 and the operating handle 32 to abut the sidewalls of the wood work-piece 50. The rotating shaft 425 is rotated to further move the abutting end 421 of the adjusting shaft 42 to push against the pushing lever 35 to make the front end of the positioning arm 31 and the abutting face 211 of the guiding mount 21 to securely clamp the wood work-piece 50 and form a structure balance between the positioning arm 31, the operating handle 32, the pushing lever 35, the clamping arm 41 and the holding grip 43 as shown in FIG. 4.

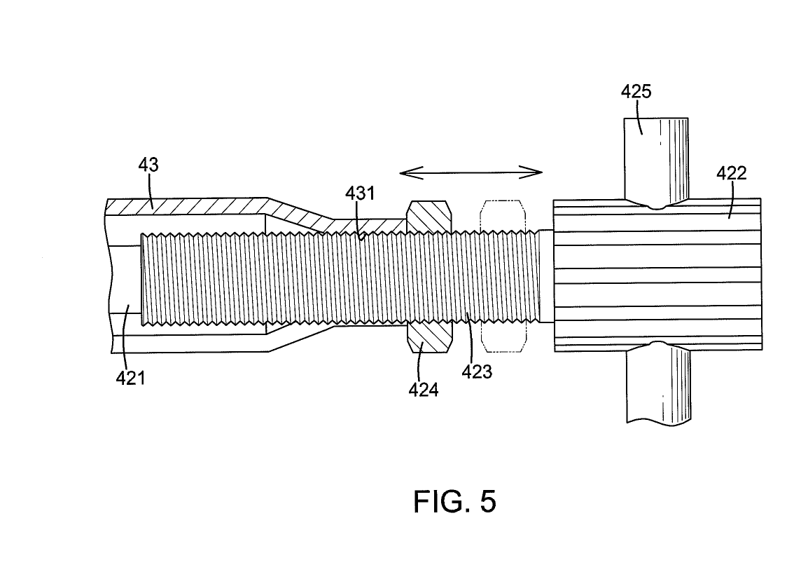

After the wood work-piece 50 is securely held between the abutting face 211 of the guiding mount 21 and the locating pad 33 of the positioning arm 31, a drill or a bit can be inserted into the guiding hole 214 via the protecting plug 216 to drill an oblique hole in the wood work-piece 50 and the saw dust can be discharged and cleaned out of the guiding mount 21 from the chip-removal holes 215. Furthermore, with further reference to FIG. 5, the length of the adjusting shaft 42 that moves into the holding grip 43 can be adjusted by changing the position of the adjusting nut 424 on the adjusting shaft 42. When the length of the adjusting shaft 42 that moves into the holding grip 43 is adjusted by the adjusting ring 424, the distance between the clamping arm 41 and the positioning arm 31 can be changed to fit different wood work-pieces 50 with different thicknesses.

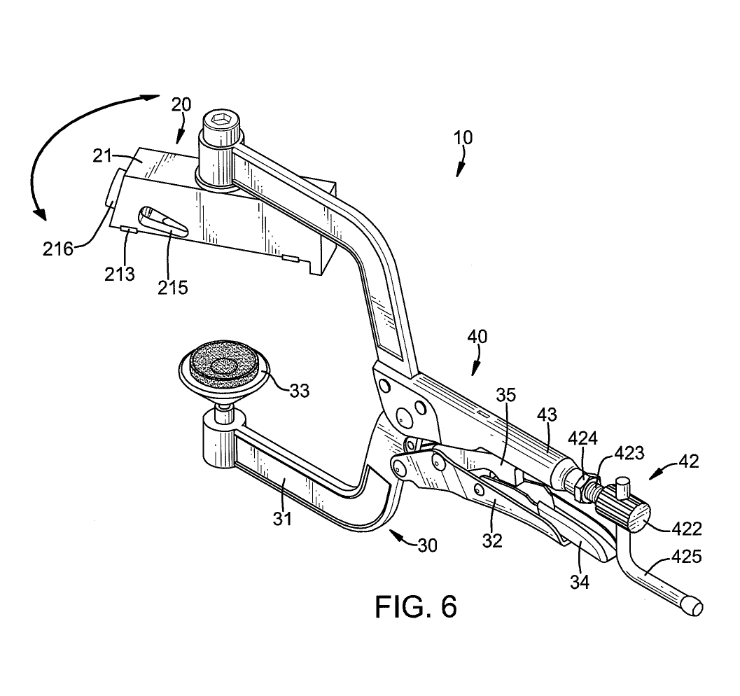

With reference to FIG. 6, the guiding mount 21 can be adjusted to rotate relative to the clamping arm 41 to hold different wood work-pieces 50 in different shapes between the guiding mount 21 and the locating pad 33 conveniently. After drilling an oblique hole in the wood work-piece 50 by the drill or the bit, the wood work-piece 50 can be separated from the guiding mount 21 and the locating pad 33 by pushing the release lever 34 toward the 43 holding grip to allow the rear end of the pushing lever 35 separating from the abutting end 421 of the adjusting shaft 42 to break the structure balance between the positioning arm 31, the operating handle 32, the pushing lever 35, the clamping arm 41 and the holding grip 43. Then, the returning spring 432 can pull the positioning arm 31 to move away the clamping arm 41 to detach the wood work-piece 50 from the guiding mount 21 and the locating pad 33.

The clamping apparatus for drilling oblique holes in accordance with the present invention has the following advantages.

1. The size and the weight of the clamping apparatus in accordance with the present invention is smaller and lighter than those of the conventional clamping apparatus and to carry the clamping apparatus in accordance with the present invention is easy and convenient.

2. Wood work-pieces 50 with different thicknesses can be held between the guiding mount 21 and the locating pad 33 by adjusting the position of the adjusting nut 424 on the adjusting shaft 42. Additionally, wood work-pieces 50 with different shapes can be held between the guiding mount 21 and the locating pad 33 by rotating the guiding mount 21 relative to the clamping arm 41. The clamping apparatus is convenient and versatile in operation.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clamping apparatus for drilling oblique holes comprising
a clamping device having
a positioning set having
a positioning arm having
a front end; and
a rear end; and
an operating handle pivotally connected to the positioning arm and having
a front end pivotally connected to the positioning arm near the rear end of the positioning arm;
a rear end;
a middle;
a release lever pivotally connected to the middle of the operating handle and having
a pivotal end pivotally connected to the middle of the operating handle; and
a releasing end extending out of the rear end of the operating handle; and
a pushing lever pivotally connected to the operating handle between the front end and the middle of the operating handle, abutting the release lever and having
a front end pivotally connected to the operating handle between the operating handle and the release lever; and
a rear end; and
a clamping set pivotally connected to the positioning set and having
a clamping arm pivotally connected to the positioning arm and having
a front end having a shape corresponding to the positioning arm;
a rear end;
a middle pivotally connected to the rear end of the positioning arm; and
a holding grip formed on the rear end of the clamping arm and having an adjusting hole being screwed and formed through the holding grip opposite to the front end of the clamping arm; and
an adjusting shaft rotatably connected to the holding grip of the clamping arm in the adjusting hole and having an abutting end mounted in the adjusting hole of the holding grip and selectively abutting the rear end of the pushing lever; and
a guiding device detachably and adjustably connected to the clamping device and having
a guiding mount detachably and adjustably connected to the front end of the clamping arm and having
a top adjustably connected to the front end of the clamping arm;
a bottom;
a front side;
two opposite sidewalls; and
a guiding hole obliquely formed through the guiding mount from the front side to the bottom of the guiding mount.

2. The clamping apparatus for drilling oblique holes as claimed in claim 1, wherein the adjusting shaft has
an external surface;
an operating end extending out of the holding grip;
an outer thread formed around the external surface of the adjusting shaft between the abutting end and the operating end and screwed with the adjusting hole of the holding grip; and
an adjusting ring adjustably and rotatably mounted around the external surface of the adjusting shaft.

3. The clamping apparatus for drilling oblique holes as claimed in claim 2, wherein the adjusting shaft has a rotating shaft connected to the operating end of the adjusting shaft.

4. The clamping apparatus for drilling oblique holes as claimed in claim 3, wherein
the holding grip has a returning spring mounted in the clamping arm near the holding grip and connected to the positioning arm near the middle of the clamping arm; and
the rear end of the pushing lever is mounted in the holding grip between the adjusting hole and the returning spring.

5. The clamping apparatus for drilling oblique holes as claimed in claim 4, wherein the positioning arm has a locating pad rotatably connected to the front end of the positioning arm and having a universal bearing to allow the locating pad rotating relative to the front end of the positioning arm.

6. The clamping apparatus for drilling oblique holes as claimed in claim 5, wherein the release lever has a torsional spring mounted in the release lever and having two ends respectively abutted the operating handle and the release lever.

7. The clamping apparatus for drilling oblique holes as claimed in claim 6, wherein the guiding mount has an abutting face formed on the bottom of the guiding mount and facing the locating pad.

8. The clamping apparatus for drilling oblique holes as claimed in claim 7, wherein the guiding mount has at least one mounting recess transversely formed on the abutting face of the guiding mount and each one of the at least one mounting recess having an anti-skid strip.

9. The clamping apparatus for drilling oblique holes as claimed in claim 8, wherein the guiding mount has two chip-removal holes respectively formed through the opposite sidewalls of the guiding mount and communicating with the guiding hole; and
a protecting socket mounted in the guiding hole at the front side of the guiding mount.

10. The clamping apparatus for drilling oblique holes as claimed in claim 1, wherein the guiding mount has an abutting face formed on the bottom of the guiding mount and facing the locating pad;
at least one mounting recess transversely formed on the abutting face of the guiding mount and each of the at least one mounting recess having an anti-skid strip;
two chip-removal holes respectively formed through the opposite sidewalls of the guiding mount and communicating with the guiding hole; and
a protecting socket mounted in the guiding hole at the front side of the guiding mount.
